(19) United States
(12) Patent Application Publication
(10) Pub. No.: US 2022/0395068 A1
(43) Pub. Date: Dec. 15, 2022

(54) Camera Enabled Tweezer System and Apparatus

(71) Applicant: Robert Camilo Lezcano, Yorkville, IL (US)

(72) Inventor: Robert Camilo Lezcano, Yorkville, IL (US)

(21) Appl. No.: 17/342,827

(22) Filed: Jun. 9, 2021

(51) Int. Cl. A45D 26/00; H04N 5/225; H04N 7/18

(52) U.S. Cl. CPC A45D 26/0066; H04N 5/2252; H04N 7/183; H04N 5/2256; A45D 2026/008

(57) ABSTRACT

A portable tweezing device that provides an improved tweezing experience by providing a light source, and a camera for live viewing of the area being tweezed. The tweezer transmits live video from the camera to the user's phone or other wireless device thus removing the need for a mirror and external lighting to view the hair or other object being tweezed.

### CROSS REFERENCE TO RELATED APPLICATIONS

None

### STATEMENT REGARDING FEDERALLY SPONSORED RESEARCH OR DEVELOPMENT

None.

### TECHNICAL FIELD

This disclosure relates to systems and methods for capture and removal of undesirable objects including hair and other facial and body protrusions.

### BACKGROUND

Tweezers have been used for decades to aid in extracting hairs and ingrown hairs from the face and body, and have been the subject of many improvements to allow for their use in reaching objects in hard to reach or hard to service areas of the body. In most cases, the use of tweezers on the face or neck required the use of a mirror in order to see the area. Bright lights, such as can normally be found in a bathroom, or in a vanity or makeup mirror were extremely helpful in illuminating the face to allow a closeup view of individual hairs or other objects to be removed by the tweezers. Even with proper illumination, close proximity to the mirror was often necessary to see the pores or hair follicles.

### SUMMARY

The present tweezing device incorporates a light source for illumination, a camera for live video capture, and wired or wireless technology for transmission of the video to the user's phone, thereby enhancing the user's ability to remove unwanted hairs or other objects from the face or body.

In one exemplary embodiment, a wireless camera enabled tweezer is described.

Certain advantages of the systems and methods include eliminating the need for an additional light source for viewing the area, eliminating the need for a mirror to view hard to reach areas of the body and face, reducing the need for a magnified mirror to get closeup views of the chin and neck, among others.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### DESCRIPTION OF DRAWINGS

The present embodiments are illustrated by way of the figures of the accompanying drawings, which may not necessarily be to scale, in which like references indicate similar elements, and in which:

FIG. 1 is a side perspective view of the wired camera enabled tweezer.

FIG. 2 is a top perspective view of the wired camera enabled tweezer.

FIG. 3 is a top perspective view of the USB end of the wired camera enabled tweezer.

FIG. 4 is a side perspective view of the battery and WiFi transmitter pack.

FIG. 5 is an exploded view of the wired camera enabled tweezer assembly.

FIG. 6 is a front perspective view of the camera enabled tweezer assembly.

FIG. 7 is a perspective view of the wireless camera enabled tweezer assembly.

### DETAILED DESCRIPTION OF ILLUSTRATIVE EMBODIMENTS

FIG. 1 shows the right-side view of the wired embodiment of the camera enabled tweezer 10. The camera body 20 extends from the back of the tweezer to the midpoint of the tweezers near the textured gripping section.

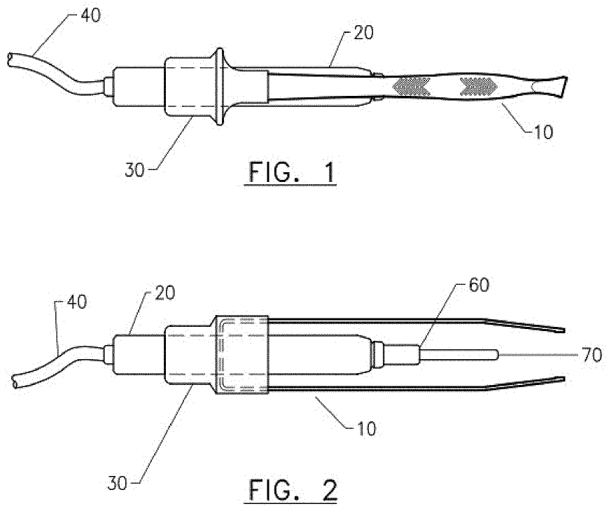

FIG. 2 shows the top view of the camera enabled tweezer 10, with the rubber boot 30 covering and supporting the connection of the camera body 20 to the tweezer arms. The LED lights 60, are positioned beyond the midpoint of the tweezer to enhance the area of illumination for the camera lens 70.

FIG. 4 shows a rechargeable wireless transmitter for the wired camera enhanced tweezer. The optical cord 40 conveys images/video from the camera body 20 to the transmitter for use with Android based smartphones via Wi-Fi, and the connection port 100 receives a USB to lightening cable for compatibility with an iPhone. for communicating those images to a smart device are seen on the top panel of the power hub.

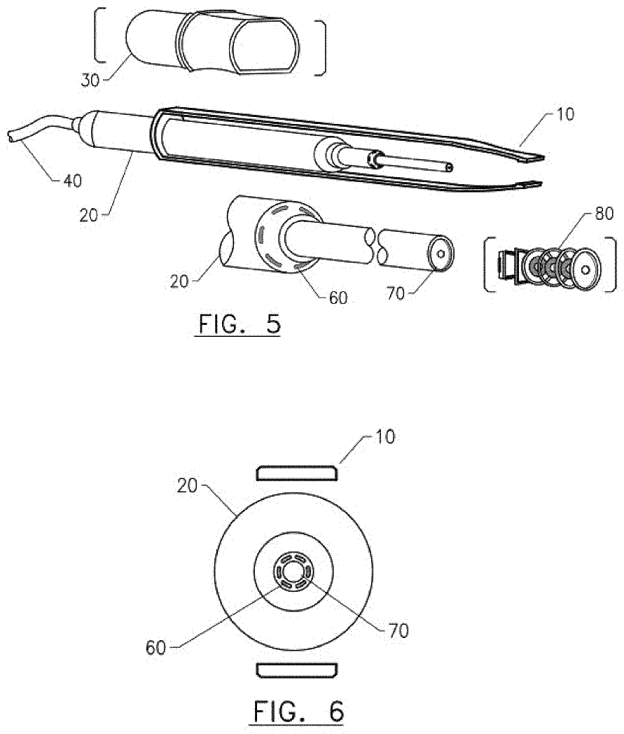

FIG. 5 shows the rubber boot 30 removed from the tweezer, exposing the bottom of the tweezer around the camera body 20. The LED lights 60 are shown at the base of the camera lens 70, as well as the micro lens assembly 80 that is inside the camera lens 70.

FIG. 6 shows a front perspective view of the camera enabled tweezer 10, with the LED lights 60, and the camera lens 70, are seen in relation to the camera body 20.

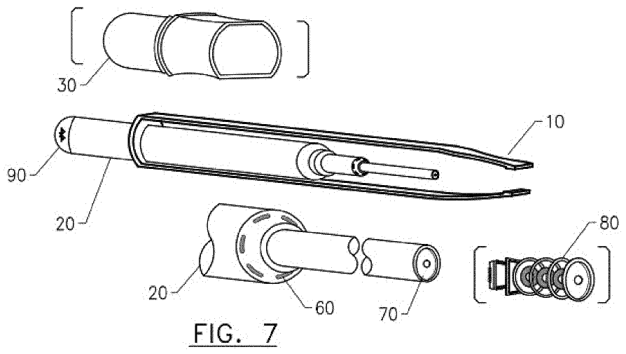

FIG. 7 shows a top perspective view of the wireless embodiment of the camera enabled tweezer 10, with the rubber boot 30 removed, wherein the wireless transceiver 90 is attached at the distal end of the camera body 20 to receive the images and/or video from the micro lens assembly 80 that is housed inside the camera lens 70. The LED lights 60 are shown encircling the proximal end of the camera body 20 to provide 360-degree illumination around the camera lens and between the gripping area of the tweezers.

The camera enable tweezer 10, permits the user to illuminate, video capture and remove a retained object such as an ingrown hair, or a comedone using one hand, while the other hand is free to hold a smartphone or other display device so that the user can clearly observe and manage the process of removal, via either a wired or a wireless connection from the camera lens 70 mounted between the two arms of the tweezer. When the camera enabled tweezer 10 is used in conjunction with a laptop or desktop computer, a larger image is viewable via the larger screen, and a second hand is no longer required, relative to when using a smartphone to display the video feed.

This combination of a tweezer, a wireless camera, an LED light source with an internal rechargeable battery (not shown) as a power source, can be used in conjunction with a wireless connection to a smart device will allow the user to observe the images in real time without the need for a mirror or an external light source.

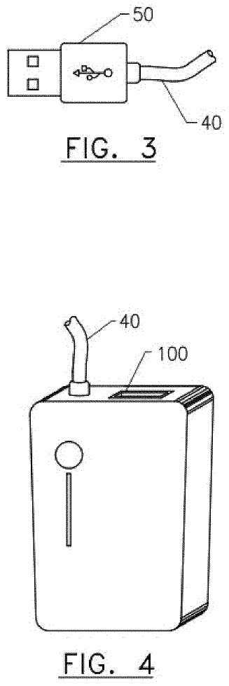

In a wired embodiment, the camera enabled tweezer 10 has an optical cable 40 connecting the end of the camera body 20 to a USB connector 50 as seen in FIG. 3. The USB connector can be plugged into various USB compatible devices including a desktop computer with a monitor, a laptop computer, or an Android based smartphone.

In an alternate wired embodiment, the optical cable 40 is connected to the camera enabled tweezer 10 on one end, and the opposite end of the optical cable is connected to the rechargeable wireless transmitter as seen in FIG. 4, which has a USB port 100 for wired connection to a smart device with a display screen such as a smart phone. The USB port 100 can also be used for connecting to a power source for recharging the camera enabled tweezer.

In a preferred wireless embodiment, the camera enabled tweezer 10 as shown in FIG. 7 transmits the video and images received from the camera via a wireless connection such as Bluetooth to a Bluetooth enabled device for display.

A number of illustrative embodiments have been described. Nevertheless, it will be understood that various modifications may be made without departing from the spirit and scope of the various embodiments presented herein. For example, the camera lens can be moved closer to the end of the tweezer for a narrower field of vision, or image magnification in the camera lens, or the LED lights can be moved closer to the end of the camera lens to increase the field of illumination. The USB connection shown is also illustrative in that represents the variant iterations of USB, including micro-USB, and USB-Type C. Accordingly, other embodiments are within the scope of the following claims.

What is claimed is:

1. A tweezer system and apparatus for personal grooming comprising:
a dual pronged tweezing member within a tweezer housing;
a camera body and lens disposed between dual prongs of the tweezing member;
a plurality of lights for illumination of the field of vision of the camera; and
an image transmission means for transferal of video from the camera to a display screen.

2. The tweezer system and apparatus of claim 1 wherein the image transmission means comprises a wireless transceiver attached to the camera body for transmission of video from the camera to a remote device such as a smart phone or other wireless video receiver.

3. The tweezer system and apparatus of claim 1 wherein the image transmission means comprises an optical cable providing a direct connection between the camera body and a USB port for connection to a smart phone or other display device.

4. The tweezer system and apparatus of claim 1, wherein the image transmission means comprises a powered USB cable for providing power to the camera and lights.

5. The tweezer system and apparatus of claim 1, further comprising a rechargeable battery as a power source.

6. The tweezer system and apparatus of claim 1 wherein the image transmission means comprises a wireless communication system or Bluetooth.

7. The tweezer system and apparatus of claim 2, further comprising a rechargeable battery as a power source.

8. The tweezer system and apparatus of claim 3, further comprising a rechargeable battery, whereby the USB connector can also be used for recharging said battery.

9. A wireless camera enabled tweezer for personal care comprising:
Two arms each having a distal, mediate and proximal portion, that are substantially equidistant at the mediate portion, connected at the distal portion, and angled toward each other to provide a pinching action at the proximal portion,
a camera disposed within the space between the two arms, being comprised of a camera body, a camera lens, and a micro lens assembly,
a casing for connection of the arms and the camera body,
a plurality of lights attached to the camera body, and
a wireless transceiver for communication between the camera and a smart device.

10. The wireless camera enabled tweezer of claim 5, further comprising a rechargeable battery source for providing power to the tweezer.

11. A method of operating a tweezer apparatus and system comprising an electronic tweezer and a mobile phone, the method comprising:
Providing a camera enabled tweezer with three or more lights surrounding the camera body for capturing live video of an area in proximity to a tweezer end;
Providing a wireless communication means for transmission of said live video to the mobile phone for display:
Illuminating an area of a face or body to be serviced with the lights, by moving the tweezers within a few inches of the area;
Displaying the video from the camera enabled tweezer on said phone or other smart device;
Using the view from the camera enabled tweezer as displayed on the phone to position the arms of the camera enabled tweezer on opposite sides of the hair or other object to be removed;
Squeezing a mediate portion of the camera enabled tweezers together such that the proximate angled ends come together to grab the hair or other object; and
Moving the camera enabled tweezers away from the face or body, while maintaining the squeezed position of the mediate portion of the tweezers to remove the hair or other object from its former position.
